(19) United States
(12) Patent Application Publication
(10) Pub. No.: US 2010/0104329 A1
(43) Pub. Date: Apr. 29, 2010

(54) MAGNETIC CARRIER, TWO COMPONENT DEVELOPER, DEVELOPING DEVICE, IMAGE FORMING APPARATUS, AND IMAGE FORMING METHOD

(76) Inventors: Nobuyuki Yoshioka, Osaka-shi (JP); Tadashi Iwamatsu, Osaka-shi (JP); Yoshinori Mutuo, Osaka-shi (JP); Hiroyuki Hirakawa, Osaka-shi (JP); Takashi Hara, Osaka-shi (JP); Takanori Kamoto, Osaka-shi (JP)

Correspondence Address: EDWARDS ANGELL PALMER & DODGE LLP, P.O. BOX 55874, BOSTON, MA, 02205, US

(21) Appl. No.: 12/451,857

(22) PCT Filed: Jul. 8, 2008
(86) PCT No.: PCT/JP2008/062355

§ 371 Date: Dec. 3, 2009

(30) Foreign Application Priority Data
Jul. 10, 2007 (JP) 2007-181431

(51) Int. Cl. G03G 15/09

(52) U.S. Cl. 399/277

(57) ABSTRACT

Regarding a magnetic carrier of the present invention, a surface of a magnetic core material is coated with a coating layer containing electrically conductive particles and a charge control agent composed of same components as components of a charge control agent contained in a electrophotographic toner. Further, the magnetic carrier exhibits an electric resistance value of 8.22×10⁷ Ωcm to 1.12×10¹⁰ Ωcm in an electric field of 4×10³ V/cm. This allows the magnetic carrier to stay capable of charging the electrophotographic toner even over a long period of time.

### TECHNICAL FIELD

The present invention relates to (i) a magnetic carrier used for development of an electrostatic latent image pattern in an image forming method employing an electrophotographic printing method, (ii) a two component developer containing the magnetic carrier and a toner, (iii) an image forming apparatus employing the two component developer, and (iv) an image forming method employing the two component developer.

### BACKGROUND ART

An image forming apparatus employing an electrophotographic printing method has been widely used as a copier, a printer, a facsimile, and the like. The image forming apparatus employing the electrophotographic printing method forms an image on recording paper through a charging step, an exposing step, a developing step, a transferring step, a cleaning step, and a fixing step. Here, the image forming apparatus employs a developer, which is (i) an electrophotographic two component developer composed of a toner for development of an electrostatic latent image and a carrier for development of the electrostatic latent image or (ii) an electrophotographic single component developer consisting only of the toner for development of the electrostatic latent image. In the former, i.e., the electrophotographic two component developer, the carrier for development of the electrostatic latent image has functions of stirring, carrying, charging, etc., and the functions of the carrier are separated from that of the toner. Therefore, as compared with the latter electrophotographic single component developer, the electrophotographic two component developer is handled more easily as a developer and makes it possible to achieve a high-quality image more easily.

The carrier for development of the electrostatic latent image is categorized into (i) a coated carrier made of magnetic core particles whose surfaces are coated with resin and (ii) an uncoated carrier. Since the developer is required to have a longer life and stability in charging in a recent image forming apparatus employing the electrophotographic printing method, the coated carrier whose surface is coated with resin has been mainly used.

As such a coated carrier, for example, there has been disclosed a partially-coated carrier in which (i) a resin coating layer obtained by adding thermoplastic resin or wax into thermosetting resin is applied to the surfaces of the magnetic core particles so that recessed parts of the magnetic core particles are filled by the resin coating layer and (ii) a coverage of each of the surfaces of the magnetic core particles is 0.1% to 60% (for example, refer to Patent Literature 1). However, in a part where the resin coating layer is thin, a spent of the partially-coated carrier due to an electrophotographic toner that is finely powdered is likely to occur, thereby deteriorating a charging property of the carrier. Further, since an electric resistance is likely to decrease in a part where the resin coating layer is thin, electric charge of the electrophotographic toner that once reached a desired charge amount leaks via a low-resistance part of the surface of the carrier. This reduces the charge amount of the electrophotographic toner. This causes scattering of the toner and/or photographic fog. Furthermore, during image development, electric charge having a polarity reverse to a polarity of electric charge of a surface of a photoreceptor tends to be injected through the part where the resin coating layer is thin, thereby causing the carrier to adhere to the surface of the photoreceptor, that is, adherence of a carrier occurs. If the carrier adheres to the photoreceptor, the carrier is not transferred to the recording paper in the transferring step, thereby causing an image with white spots. This is a cause of a fatal defect in an image. Particularly under a high-humidity environment, this phenomenon noticeably occurs.

Further, there has recently been proposed another carrier, which is improved in the stability in charging of carrier particles and also is prevented from adhering to the photoreceptor, by (i) first filling a resin agent containing electrically conductive particles into recessed parts of the magnetic core particles and (ii) then additionally providing an even coating layer on the surfaces of the magnetic core particles (for example, refer to Patent Literature 2). However, since this carrier has a two-phased coating that is obtained by filling resin containing an electrically conductive material into the recessed parts of the magnetic core particles and then additionally coating the surfaces of the carrier particles with the resin layer, cost increase occurs. In addition, resistance of the surface of the carrier is uniformized only in a case where the resin contains the electrically conductive material having a resistance equivalent to a resistance of the magnetic core particles. As a result, each of the carrier particles has both a high-resistance area and a low-resistance area mixedly present on a surface of each carrier particles, thereby, for example, reducing the charge amount of the electrophotographic toner. This causes photographic fog and/or scattering.

Moreover, recently, the electrostatic latent image pattern has been improved to have a high resolution, by exposing means utilizing a small diameter laser beam with respect to an electrostatic latent image bearing member. This improvement is accompanied by reduction in particle size of the electrophotographic toner and the carrier particles for performing development faithfully to the electrostatic latent image pattern. Indeed, the reduction of an average particle size of the carrier particles is advantageous for performing faithful development of the electrostatic latent image pattern because a magnetic brush can be softened and densified; however, more of the carriers each having a small particle size adhere to an image section and a non-image section. These problems have been worked by study of magnetic force and carrier resistance and study of the carrier resistance and surface property (for example, refer to Patent Literature 3). However, the problems have not yet been solved.

### Citation List

Patent Literature 1

Japanese Patent Application Publication, Tokukaihei, No. 8-44118 A (Publication Date: Feb. 16, 1996)

Patent Literature 2

Japanese Patent Application Publication, Tokukai, No. 2002-278165 A (Publication Date: Sep. 27, 2002)

Patent Literature 3

Japanese Patent Application Publication, Tokukai, No. 2005-300734 A (Publication Date: Oct. 27, 2005)

### SUMMARY OF INVENTION

The present invention has been made in view of the foregoing problems, and an object of the present invention is to achieve a carrier for electrostatic latent image development and a two component developer each of which is free from the foregoing problems. Specifically, an object of the present invention is to achieve a magnetic carrier, a two component developer, a developing device, an image forming apparatus, and an image forming method each of which causes no adherence of a carrier to a surface of an image bearing member, prevents or inhibits photographic fog, and causes no deterioration in a charging property of a toner even over a long period of time.

The inventors of the present invention diligently worked to solve the foregoing problems, and found the following. That is, by adjusting a content of electrically conductive fine particles and a charge control agent contained in the resin material serving as a coating material in a carrier that is for development of an electrostatic latent image and that is formed by coating surfaces of magnetic core particles with a resin material, a resistance value of the carrier for development of the electrostatic latent image after coating is arranged to satisfy a specified condition. This significantly decreases an amount of the carrier that is for development of the electrostatic latent image and that adheres to a surface of an electrostatic latent image bearing member (photoreceptor). Further, it is also possible to inhibit deterioration in charging of the toner over time and to stabilize a charging property of an electrophotographic toner, by employing, in the carrier, a charge control agent composed of the same material as the charge control agent contained in the electrophotographic toner to be used in a two component developer.

That is, in order to attain the object, a magnetic carrier according to the present invention is a magnetic carrier constituting, together with an electrophotographic toner, a two component developer, the magnetic carrier having a magnetic core material whose surface is coated with a coating layer containing electrically conductive particles and a charge control agent composed of same components as components of a charge control agent contained in the electrophotographic toner, the magnetic carrier exhibiting an electric resistance value of 8.22×10⁷ Ωcm to 1.12×10¹⁰ Ωcm in an electric field of 4×10³ V/cm.

With this configuration, adherence of the carrier to an image section and a non-image section is significantly reduced, and no image deterioration such as white spots which are produced during a transfer occurs in the image section. Further, in the non-image section, no image defect in a form of a streak occurs, because a surface of a cleaning blade and a surface of an electrostatic latent image bearing member are not damaged. As such, it is possible to achieve a high-quality image. Furthermore, since the charging property of the electrophotographic toner is improved and therefore a larger proportion of the electrophotographic toner has a stable charge, photographic fog does not occur in a background area when a density of an image is high. As a result, it is possible to achieve an image having an excellent quality over a long period of time.

As described above, the use of the magnetic carrier of the present invention makes it possible to achieve a good charging property of the electrophotographic toner not only initially but also over a long period of time. Accordingly, the use of the two component developer containing the magnetic carrier configured as described above makes it possible to stably output high-quality images without causing the photographic fog in the background area on the electrostatic latent image bearing member.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a diagram schematically illustrating a toner and a carrier that are included in a developer, according to an embodiment of the present invention.

FIG. 2

FIG. 2 is a schematic view illustrating a developing device according to the embodiment of the present invention.

### DESCRIPTION OF EMBODIMENTS

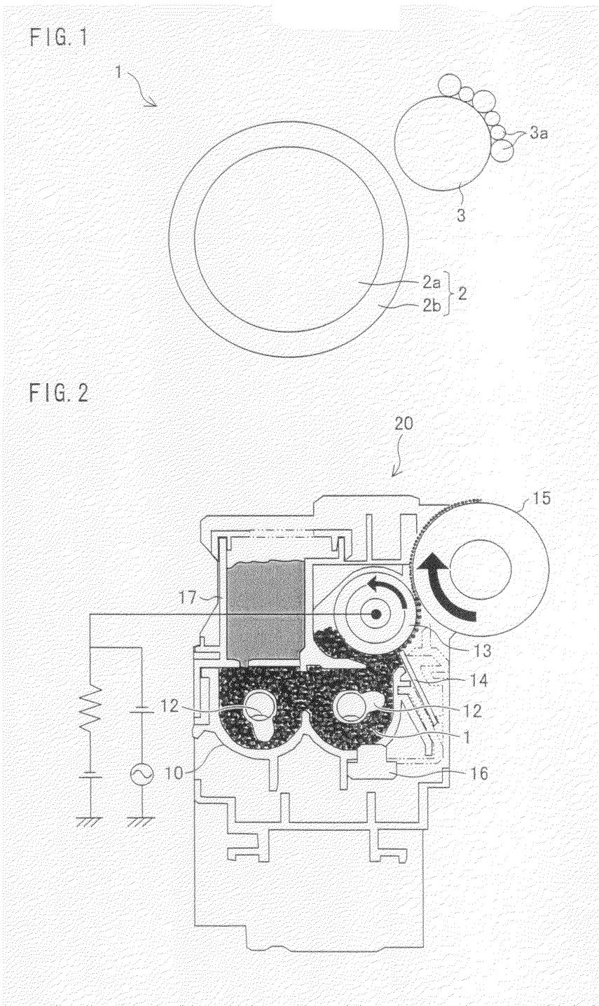

An embodiment of the present invention is described below with reference to FIGS. 1 and 2.

A two component developer 1 according to the present embodiment is a developer containing an electrophotographic toner 3 and a magnetic carrier 2. The following describes the electrophotographic toner 3, the magnetic carrier 2, and the two component developer 1 in this order.

### (Electrophotographic Toner)

The electrophotographic toner 3 essentially contains binder resin and a colorant as toner materials, and further contains, for example, a charge control agent, a release agent, and a flow improver. Note that in the present embodiment, the flow improver is used as an external additive 3a.

The binder resin is not limited to a particular kind, and any known binder resin for a black toner or a color toner can be used. Examples of the binder resin encompass: a polyester resin; a styrene resin such as polystyrene or a styrene-acrylic acid ester copolymer resin; an acrylic resin such as polymethylmethacrylate; a polyolefin resin such as polyethylene; polyurethane; and an epoxy resin. Moreover, the binder resin may be a resin obtained by polymerizing a mixture of a raw monomer mixture and the release agent. The binder resins may be used alone individually or in combination of two or more.

In a case where the polyester resin is used as the binder resin, examples of an aromatic alcohol component used to obtain the polyester resin may be bisphenol-A, polyoxyethylene-(2.2)-2,2-bis(4-hydroxyphenyl)propane, polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxypropylene-(6)-2,2-bis(4-hydroxyphenyl)propane, polyoxypropylene-(2.2)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, and derivatives of these.

Examples of a polybasic acid component of the polyester resin encompass: dibasic acids such as succinic acid, adipic acid, sebacic acid, azelaic acid, dodecenylsuccinic acid, n-dodecylsuccinic acid, malonic acid, maleic acid, fumaric acid, citraconic acid, itaconic acid, glutaconic acid, cyclohexanedicarboxylic acid, orthophthalic acid, isophthalic acid, or terephthalic acid; tribasic or higher acids such as trimellitic acid, trimethine acid, or pyromellitic acid, and anhydrides of these; and lower alkyl esters. Out of these, terephthalic acid or a lower alkyl ester thereof is preferable in view of heat resistance and cohesiveness. Acid number of the polyester resin, which constitutes the electrophotographic toner, is preferably 5 mgKOH/g to 30 mgKOH/g. If the acid number is less than 5 mgKOH/g, then a charging property of the polyester resin deteriorates, and the charge control agent becomes hard to disperse in the polyester resin. This adversely affects (i) an initial rise of a charge amount and (ii) a stability of the charge amount in repetitive developments which are performed through continuous use.

As the colorant, various kinds of colorants may be used according to desired colors. For example, the colorant may be a colorant for a yellow toner, a colorant for a magenta toner, a colorant for a cyan toner, or a colorant for a black toner.

Examples of the colorant for a yellow toner encompass: azo pigment such as C.I. pigment yellow 1, C.I. pigment yellow 5, C.I. pigment yellow 12, C.I. pigment yellow 15, or C.I. pigment yellow 17; an inorganic pigment such as yellow iron oxide or loess; a nitro dye such as C.I. acid yellow 1; and an oil-soluble dye such as C.I. solvent yellow 2, C.I. solvent yellow 6, C.I. solvent yellow 14, C.I. solvent yellow 15, C.I. solvent yellow 19, or C.I. solvent yellow 21, which are classified according to a color index.

Examples of the colorant for a magenta toner encompass: C.I. pigment red 49, C.I. pigment red 57, C.I. pigment red 81, C.I. pigment red 122, C.I. solvent red 19, C.I. solvent red 49, C.I. solvent red 52, C.I. basic red 10, and C.I. disperse red 15, which are classified according to the color index

Examples of the colorant for a cyan toner encompass: C.I. pigment blue 15, C.I. pigment blue 16, C.I. solvent blue 55, C.I. solvent blue 70, C.I. direct blue 25, and C.I. direct blue 86, which are classified according to the color index.

Examples of the colorant for a black toner encompass: carbon blacks such as channel black, roller black, disk black, gas furnace black, oil furnace black, thermal black, or acetylene black. A carbon black may be selected from these various kinds of carbon blacks as appropriate according to a desired design characteristic of the electrophotographic toner.

The colorant may also be a crimson pigment, a green pigment, or the like pigment, other than the above described pigment. The colorants may be used alone individually, or in combination of two or more. Moreover, two or more colorants of similar colors may be used, or alternatively, one or a combination of two or more of colorants of different colors may be used.

The colorant is used in a form of a masterbatch. The masterbatch of the colorant can be produced in the same manner as a general masterbatch. For example, the masterbatch can be produced by (i) dispersing the colorant uniformly in a molten synthetic resin by kneading the molten synthetic resin together with the colorant, and (ii) thereafter, granulating a resultant material obtained. The synthetic resin is of the same type as the binder resin of the electrophotographic toner 3, or a synthetic resin having a good compatibility with the binder resin of the electrophotographic toner 3. Here, a ratio of the synthetic resin to the colorant is not limited in particular; however, it is preferable that the ratio of the colorant be 30 parts to 100 parts by weight with respect to 100 parts by weight of the synthetic resin. Moreover, the masterbatch is granulated so as to have a particle size of approximately 2 mm to 3 mm.

An amount of the colorant is not particularly limited; however, it is preferable that the amount be 5 parts to 20 parts by weight with respect to 100 parts by weight of the binder resin. This amount is not an amount of the masterbatch, but an amount of the colorant itself contained in the masterbatch. The use of the colorant in the amount within the above-described range allows formation of an image which has a high image density and has an extremely high quality, without damaging physical properties of the electrophotographic toner 3.

The charge control agent is added to control a triboelectric charging property of the electrophotographic toner 3. The charge control agent may be selected from charge control agents that are for positive electric charge or for negative electric charge and that are commonly used in this field. Examples of the charge control agent for positive electric charge encompass: a nigrosine dye, a basic dye, quaternary ammonium salt, quaternary phosphonium salt, aminopyrine, a pyrimidine compound, a polynuclear polyamino compound, aminosilane, a nigrosine dye and a derivative thereof, a triphenylmethane derivative, guanidine salt, and amidine salt. Examples of the charge control agent for negative electric charge encompass: an oil soluble dye such as oil black or spirone black; a metal-containing azo compound; an azo complex dye; metal naphthenate; a metal complex of salicylic acid, a metal complex of a derivative of salicylic acid, metal salt of salicylic acid, and metal salt of the derivative of salicylic acid (the metal is chromium, zinc, zirconium, etc.); a boron compound; fatty acid soap; long-chain alkylcarboxylic acid salt; and resin acid soap. Out of these, the boron compound is particularly preferable because the boron compound is free from heavy metal. Either the charge control agent for positive electric charge or the charge control agent for negative electric charge may be used depending on each application. The charge control agents may be used alone individually or in combination of two or more as appropriate. An amount of the charge control agent is not particularly limited and may be selected from a wide range of amounts as appropriate; however, the amount of the charge control agent is preferably 0.5 parts to 3 parts by weight with respect to 100 parts by weight of the binder resin.

The release agent may be a release agent commonly used in this field. Examples of the release agent encompass: petroleum wax such as paraffin wax or a derivative thereof, and microcrystalline wax and a derivative thereof; hydrocarbon synthetic wax such as Fischer-Tropsch wax or a derivative thereof, polyolefin wax and a derivative thereof, low-molecular-weight polypropylene wax and a derivative thereof, and polyolefin polymer wax (such as low-molecular-weight polyethylene wax) and a derivative thereof; plant wax such as carnauba wax or a derivative thereof, rice wax and a derivative thereof, candelilla wax and a derivative thereof, and Japan wax; animal wax such as bees wax or sipermaceti wax; oil and fat synthetic wax such as fatty acid amide or phenol fatty acid ester; long-chain carboxylic acid and a derivative thereof; long-chain alcohol and a derivative thereof; silicone polymer; and higher fatty acid. Note that the derivative encompasses, for example, an oxide, a block copolymer of a vinyl monomer and wax, and wax graft-modified with a vinyl monomer. An amount of the release agent to be used is not particularly limited and may be selected from a wide range of amounts as appropriate; however, the amount is preferably 0.2 parts to 20 parts by weight with respect to 100 parts by weight of the binder resin.

The flow improver is used as the external additive 3a, and becomes effective for example by adhering to a surface of the electrophotographic toner 3. The flow improver may be a flow improver commonly used in this field. Examples of the flow improver encompass: silicon oxide, titanium oxide, silicon carbide, aluminum oxide, and barium titanate. The flow improvers may be used alone individually or in combination of two or more. An amount of the flow improver is not particularly limited; however, the amount is preferably 0.1 parts to 3.0 parts by weight with respect to 100 parts by weight of the electrophotographic toner 3.

These raw materials of the electrophotographic toner 3 as so far described, except for the flow improver, are mixed with use of a mixer such as a Henschel Mixer, a super mixer, a Mechano Mill, or a Q-type mixer. A mixture of the raw materials obtained is fused and kneaded at a temperature of approximately 70° C. to 180° C. with use of a kneader such as a biaxial kneader, a uniaxial kneader, or an continuous double-roll type kneader, and then solidified by cooling. The molten kneaded material of the raw materials of the electrophotographic toner 3 is solidified by cooling and then roughly ground with use of a cutter mill, a feather mill, or the like. Thereafter, the roughly ground mixture is further finely pulverized with use of an airflow-type jet mill, a fluidized-bed jet mill, or the like. These mills for fine pulverization pulverize toner particles by causing the toner particles to collide with each other. This collision is produced by causing airflows containing the toner particles to collide with each other from a plurality of directions. Such mills are commercially available from, for example, HOSOKAWA MICRON CORPORATION. Such pulverization makes it possible to produce a nonmagnetic electrophotographic toner having a specific particle size distribution. The electrophotographic toner 3 is not particularly limited in terms of a particle size, but preferably has a volume average particle size of 5 μm to 7 μm. The electrophotographic toner 3 may be further adjusted in terms of the particle size as appropriate by performing, for example, classification. To the electrophotographic toner 3 produced as described above, the flow improver is added through a known method. Note that a production method of the electrophotographic toner 3 is not limited to the above-described method.

### (Magnetic Carrier)

In view of, for example, giving sufficient charge to the electrophotographic toner 3, the magnetic carrier 2 is preferably a carrier made in such a manner that a coating layer 2b is provided on a surface of a carrier core (magnetic core particle, magnetic core material) 2a. The coating layer 2b is made of a resin composition containing a charge control material and electrically conductive fine particles.

The carrier core 2a may be any carrier core commonly used in this field. The carrier core 2a may be made of, for example: magnetic metal such as iron, copper, nickel, or cobalt; or magnetic metal oxide such as ferrite or magnetite. With the carrier core 2a which is made of such a magnetic material, it is possible to obtain a magnetic carrier 2 suitable for a two component developer for use in a magnetic brush developing method. A volume average particle size of the magnetic core 2a is preferably 25 μm to 150 μm, and particularly preferably 25 μm to 90 μm. In this specification, the volume average particle size is a value measured with use of a particle size analyzer (Product Name: Microtrac MT3000, by NIKKISO CO., LTD.).

The resin composition (a coating resin composition) constituting the coating layer 2b on the surface of the carrier core 2a is a resin composition containing, in resin, (i) a charge control agent composed of same components as those of the charge control agent included in the electrophotographic toner 3 and (ii) electrically conductive fine particles.

The resin of the coating resin composition is not particularly limited and may be a known resin; however, in view of compatibility between (i) releasability from the electrophotographic toner 3 and (ii) adhesiveness to the carrier core 2a, it is preferable to use silicone resin to attain a better effect.

The silicone resin is not particularly limited and may be a silicone resin commonly used in this field; however, it is preferable to use crosslinkable silicone resin. The crosslinkable silicone resin is a known silicone resin which is cured in such a manner that (i) hydroxyl groups each bonding with respective Si atoms or (ii) a hydroxyl group each bonding with an Si atom and an -OX group bonding with another Si atom are cross-linked to each other through a thermal dehydration reaction, a room temperature curing reaction, or the like reaction, as shown in the following chemical formulae.

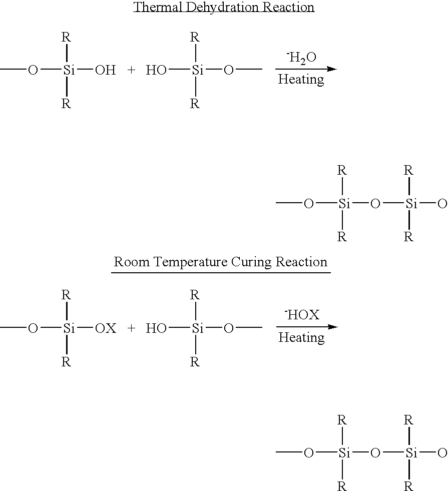

(where: Rs represent identical groups or different univalent organic groups; an —OX group represents an acetoxy group, an aminoxy group, an alkoxy group, an oxime group, or the like.)

The crosslinkable silicone resin that is usable may be a heat curing type silicone resin or a room temperature curing type silicone resin. The heat curing type silicone resin needs to be heated to approximately 200° C. to 250° C. so that the heat curing type silicone resin is cross-linked. The room temperature curing type silicone resin is cured without heat; however, the room temperature curing type silicone resin is preferably heated at a temperature of 150° C. to 280° C. for shorting a time for curing.

Among crosslinkable silicone resins, a resin whose univalent organic group represented by R is a methyl group is preferable. Since such a crosslinkable silicone resin has a dense cross-linked structure, such a crosslinkable silicone resin whose R is the methyl group provides a magnetic carrier 2 excellent in water repellency, moisture resistance, and the like when the crosslinkable silicone resin is used to form the coating layer 2b. Note however that if the crosslinkable structure is too dense, a resin coating layer tends to be brittle. Therefore, it is important to choose an appropriate molecular weight of the crosslinkable silicone resin.

Further, in the crosslinkable silicone resin, a weight ratio of silicon to carbon (Si/C) preferably ranges from 0.3 to 2.2. If the weight ratio is lower than 0.3, then a hardness of the resin coating layer may deteriorate. This may shorten a life of the carrier. On the other hand, if the weight ratio is higher than 2.2, then a charge-imparting property of the carrier with respect to the toner may become more easily affected by temperature changes. This may cause embrittlement of the resin coating layer.

In a case where the crosslinkable silicone resin is used for the coating resin composition, a commercially available crosslinkable silicone resin may be used. Examples of such crosslinkable silicone resin encompass: SR2400, SR2410, SR2411, SR2510, SR2405, 840RESIN, and 804RESIN (product names, manufactured by Dow -Corning Toray Co., Ltd.); and KR271, KR272, KR274, KR216, KR280, KR282, KR261, KR260, KR255, KR266, KR251, KR155, KR152, KR214, KR220, X-4040-171, KR201, KR5202, and KR3093 (product names, manufactured by Shin-Etsu Chemical Co., Ltd.). The crosslinkable silicone resins may be used alone individually or in combinations of two or more kinds.

The charge control agent contained in the coating layer 2b is preferably a charge control agent containing the same component as that of the charge control agent contained in the electrophotographic toner 3.

Accordingly, as the charge control agent of the magnetic carrier 2, a charge control agent for positive electric charge or for negative electric charge may be used in accordance with the charge control agent contained in the electrophotographic toner 3. Examples of the charge control agent for positive electric charge encompass: a nigrosine dye, a basic dye, quaternary ammonium salt, quaternary phosphonium salt, aminopyrine, a pyrimidine compound, a polynuclear polyamino compound, aminosilane, a nigrosine dye and a derivative thereof, a triphenylmethane derivative, guanidine salt, and amidine salt. Examples of the charge control agent for negative electric charge encompass: an oil-soluble dye such as oil black or spirone black; a metal-containing azo compound; an azo complex dye; metal naphthenate; a metal complex of salicylic acid, a metal complex of a derivative of salicylic acid, metal salt of salicylic acid, and metal salt of the derivative of salicylic acid (metal is chromium, zinc, zirconium, etc.); a boron compound; fatty acid soap; long-chain alkylcarboxylic acid salt; and resin acid soap. Out of these, the boron compound is particularly preferable because it is free from heavy metal. The charge control agents may be used alone individually or in combination of two or more. An amount of the charge control agent to be used is not particularly limited and may be selected from a wide range of amounts as appropriate; however, the amount is preferably 5 parts to 15 parts by weight with respect to 100 parts by weight of the resin contained in the coating resin composition.

The electrically conductive particles may be made of, for example, an electrically conductive carbon black, and an oxide such as electrically conductive titanium oxide or tin oxide. For providing electric conductivity by adding a small amount of the electrically conductive particles, the carbon black etc. is suitably used. However, carbon may come off from the coating layer 2b of the magnetic carrier 2 when used in a color toner. In such a case, for example, electrically conductive titanium oxide doped with antimony is used. An amount of the electrically conductive particles to be used is not particularly limited and may be selected from a wide range of amounts as appropriate; however, the amount is preferably 10 parts by weight or less with respect to 100 parts by weight of the resin contained in the coating resin composition.

The magnetic carrier 2 may further contain a silane coupling agent for adjusting a charge amount of the electrophotographic toner 3. More specifically, a silane coupling agent having an electron-donating functional group is preferably used. A specific example of the silane coupling agent is an amino-group-containing silane coupling agent. The amino-group-containing silane coupling agent may be a known amino-group-containing silane coupling agent. The amino-group-containing silane coupling agent may be represented by the following general formula (1), for example.

(Y)nSi(R)m (1)

(In the formula, the number m of Rs represent identical or different alkyl groups, alkoxy groups or chlorine atoms. The number n of Ys represent hydrocarbon groups containing identical or different amino groups. Each of m and n represents an integer in a range of 1 to 3. Note however that m+n=4.)

In Formula (1), the alkyl group represented by R may be, for example, a straight-chain or branched-chain alkyl group having a carbon number of 1 to 4 such as a methyl group, an ethyl group, a propyl group, an isopropyl group, a butyl group, an isobutyl group, or a tert-butyl group. Out of these, the methyl group, the ethyl group, and the like are preferable. Examples of the alkoxy group encompass: a straight-chain or branched-chain alkoxy group having a carbon number of 1 to 4 such as a methoxy group, an ethoxy group, a propoxy group, an isopropoxy group, a butoxy group, an isobutoxy group, or a tert-butoxy group. Out of these, the methoxy group, the ethoxy group, and the like are preferable. The amino-group containing hydrocarbon group which is represented by Y may be, for example, —(CH₂)a-X (where: X represents an amino group, an aminocarbonyl amino group, an aminoalkyl amino group, a phenylamino group, or a dialkylamino group; and a represents an integer of 1 to 4.), and -Ph-X (where X is the same as the above, and -Ph -represents a phenylene group).

Specific examples of the amino-group-containing silane coupling agent may be:

H₂N(H₂C)₃Si(OCH₃)₃,

H₂N(H₂C)₃Si(OC₂H₅)₃,

H₂N(H₂C)₃Si(CH₃)(OCH₃)₂,

H₂N(H₂C)₂HN(H₂C)₃Si(CH₃)(OCH₃)₂,

H₂NOCHN(H₂C)₃Si(OC₂H₅)₃,

H₂N(H₂C)₂HN(H₂C)₃Si(OCH₃)₃,

H₂N-Ph-Si(OCH₃)₃ (where -Ph- represents a p-phenylene group),

Ph-HN(H₂C)₃Si(OCH₃)₃ (where Ph- represents a phenyl group), or

(H₉C₄)₂N(H₂C)₃Si(OCH₃)₃.

The amino-group-containing silane coupling agents may be used alone individually or in combination of two or more. An amount of the amino-group-containing silane coupling agent is determined as appropriate so that the amount of the amino-group-containing silane coupling agent is in a range that gives a sufficient amount of electric charge to the electrophotographic toner 3 without significantly decreasing a mechanical strength etc. of the coating layer 2b. The amount is preferably 10 parts by weight or less, more preferably 0.01 parts to 10 parts by weight, with respect to 100 parts by weight of the resin contained in the coating resin composition.

The coating resin composition may further contain, other than the silicone resin, another resin in a range in which the resin coating layer formed by using the silicone resin (particularly, the crosslinkable silicone resin) keeps a desirable characteristic of the resin coating layer. Examples of the another resin encompass: an epoxy resin, a urethane resin, a phenol resin, an acrylic resin, a styrene resin, polyamide, polyester, an acetal resin, polycarbonate, a vinyl chloride resin, a vinyl acetate resin, a cellulosic resin, polyolefin, a copolymer resin of these, and a compounded resin of these.

The coating resin composition may contain bifunctional silicone oil in order to further improve, for example, moisture resistance and releasability of the resin coating layer made of the silicone resin (particularly, the crosslinkable silicone resin).

The coating resin composition can be produced by mixing a predetermined amount of a silicone resin and an amino-group-containing silane coupling agent, and, as appropriate, a proper amount of a resin other than the silicone resin and an additive such as bifunctional silicone oil. An example of a form of the coating resin composition is a solution which is obtained by dissolving above-described components in an organic solvent. The organic solvent is not particularly limited as long as the organic solvent is capable of dissolving the silicone resin. Examples of the organic solvent encompass: aromatic hydrocarbons such as toluene or xylene; ketones such as acetone or methyl ethyl ketone;

ethers such as tetrahydrofuran or dioxane; higher alcohols; and a mixed solvent of two or more of these organic solvents. Use of the coating resin composition in a form of solution (hereinafter, referred to as “coating resin solution”) makes it possible to easily form the coating layer 2b on the surface of the carrier core 2a. The magnetic carrier 2 can be produced, for example, through a procedure in which: the coating resin solution is applied to the surface of the carrier core 2a, thereby forming a solution-applied layer; the solution-applied layer is heated so that the organic solvent is volatilized and removed; and the solution-applied layer is cured by heat or simply cured during drying or after drying so that the coating layer 2b is formed.

A method for applying the coating resin solution to the surface of the carrier core 2a may be, for example, a dipping method in which the carrier core 2a is dipped in the coating resin solution, a spraying method in which the coating resin solution is sprayed on the carrier core 2a, or a fluidized-bed method in which the coating resin solution is sprayed on the carrier core 2a suspended in a fluidized airflow. Out of these, the dipping method is preferable because a film can be formed easily.

The solution-applied layer may be dried by using a dry accelerator. The dry accelerator may be a known dry accelerator. Examples of the dry accelerator encompass: metal soap such as lead salt, iron salt, cobalt salt, manganese salt, or zinc salt, containing such as naphthyl acid or octylic acid; and organic amines such as ethanolamine. The dry accelerators may be used alone individually or in combination of two or more.

The solution-applied layer is cured by heating at a temperature selected according to a type of the silicone resin. It is preferable that the heating is carried out at a temperature in a range of, for example, approximately 150° C. to 280° C. In a case where the silicone resin is a room temperature curing type silicone resin, the coating layer is cured without heating. However, for the purpose of (i) improving a mechanical strength of the resin coating layer to be formed and (ii) shortening a time for curing, the silicone resin may be heated to a temperature of approximately 150° C. to 280° C.

The coating resin solution is not particularly limited in terms of a total solid content concentration, and may be adjusted so that a film thickness of the coating layer 2b after curing is 5 μm or less in a normal state and preferably approximately 0.1 μm to 3 μm, in view of workability of the coating resin solution in application of the coating resin solution to the carrier core 2a.

The magnetic carrier 2 obtained as described above preferably has a high electric resistance and a spherical shape. However, the magnetic carrier 2 which is electrically conductive and which has a nonspherical shape does not adversely affect an effect of the present invention.

### (Two Component Developer)

The two component developer 1 is produced by mixing the electrophotographic toner 3 and the magnetic carrier 2 with each other. A mixture ratio of the electrophotographic toner 3 with respect to the magnetic carrier 2 is not particularly limited; however, in view of use in a high-speed image forming apparatus (by which images in A4 size can be formed at a speed of 40 sheets/min or more), a ratio of a total projected area of the toner (the sum of projected area of all toner particles) to a total surface area of the carrier (the sum of surface areas of all the toner particles), which is calculated according to a formula of (a total projected area of the toner/a total surface area of the carrier×100), should be 30% to 70% under a condition where a volume average particle size of the carrier divided by a volume average particle size of the toner is 5 or higher. At the ratio, the charging property of the electrophotographic toner 3 can be stably maintained in a sufficiently good condition. Accordingly, the two component developer 1 can be used as a suitable developer capable of stably forming high quality images over a long period of time even in the high-speed image forming apparatus. For example, in a case where: (i) the volume average particle size of the electrophotographic toner 3 is 6.5 μm; (ii) the volume average particle size of the magnetic carrier 2 is 90 μm; and (iii) the ratio of the total projected area of the electrophotographic toner 3 to the total surface area of the magnetic carrier 2 is 30% to 70%, the two component developer 1 contains the electrophotographic toner 3 in an amount of approximately 2.2 parts to 5.3 parts by weight with respect to 100 parts by weight of the magnetic carrier 2. When such a two component developer 1 is used in high-speed development, both an amount of a toner being carried and a supply of a toner that is supplied to a developer tank of the developing device in accordance with a consumption of the toner become maximum. However, a balance between supply and demand is not impaired. If the amount of the magnetic carrier 2 contained in the two component developer 1 is larger than approximately 2.2 parts to 5.3 parts by weight, then the amount of toner being carried becomes too small to attain a desired developing characteristic. In contrast, if the amount of the magnetic carrier 2 is smaller than the above-described range, then the toner tends to retain smaller charge, thereby causing photographic fog, instability of development density, or the like. This leads to deterioration in image quality.

In the present embodiment, the total projected area of the toner is calculated as follows. The total project area of the toner is calculated based on a volume average particle size measured with use of a Coulter Counter (product name: Coulter Counter Multisizer II, manufactured by Beckman Coulter, Inc.). Here, a specific gravity of the toner is 1.0. That is, the number of toner particles with respect to a weight of the toner to be mixed is calculated, and then the number of the toner particles is multiplied by an area of the toner (calculated by assuming as a circle) to find the total projected area of the toner. Similarly, the total surface area of the carrier is calculated from a weight of the carrier to be mixed based on a particle size measured with use of a Microtrac (product name: Microtrac MT3000, manufactured by NIKKISO CO., LTD.). Here, a specific gravity of the carrier is 4.7. A mixture ratio of the toner to the carrier is calculated through a formula of: the total projected area of the toner/the total surface area of the carrier×100.

### (Developing Device and Image Forming Apparatus)

A developing device 20 of the present embodiment performs development of an image by using the two component developer 1 of the present embodiment. As illustrated in FIG. 2, the developing device 20 includes a developing unit 10 in which the two component developer 1 is stored, and a developer bearing member 13 which carries the two component developer 1 to an electrostatic latent image bearing member 15.

The two component developer 1 of the present embodiment is composed of a magnetic carrier 2 and an electrophotographic toner 3, and provided in the developing unit 10 in advance. This two component developer 1 is stirred and charged by a stirring screw 12. Next, the two component developer 1 is carried to the developer bearing member 13 having magnetic field generating means inside the developer bearing member 13, thereby being carried onto a surface of the developer bearing member 13. The two component developer 1 held on the surface of the developer bearing member 13 is (i) controlled to have a predetermined layer thickness by a developer controlling member 14, and then (ii) carried to a developing area which is provided in an area where the developer bearing member 13 and the electrostatic latent image bearing member 15 are located close to each other. Since an electric field caused by developing bias exists between the developer bearing member 13 and the electrostatic latent image bearing member 15, the electrophotographic toner 3 contained in the two component developer 1 held on the developer bearing member 13 electrically adheres to an electrostatic latent image pattern on the electrostatic latent image bearing member 13. As a result, an image is made visible. In a case where an alternating-current bias voltage is applied between the developer bearing member 13 and the electrostatic latent image bearing member 15, a development efficiency is improved by an alternating current. This makes it possible to stably obtain an image density ranging from a high image density to a halftone image density. A consumption of the toner is detected by a toner concentration sensor 16, and an amount of the toner consumed is supplied from a toner hopper 17 until the toner concentration sensor 16 detects that a predetermined toner concentration is reached. As such, the toner concentration is kept substantially constant in the two component developer 1 inside the developing unit 10.

An image forming apparatus of the present embodiment includes the developing device 20 described above. Other than the above configuration, it is possible to employ configurations of a known image forming apparatus employing an electrophotographic printing method. For example, the image forming apparatus includes: an image bearing member having, on a surface of the image bearing member, a photosensitive layer on which an electrostatic charge image can be formed; charging means for charging the surface of the image bearing member to have a predetermined electric potential; exposing means for forming the electrostatic charge image (electrostatic latent image) on the surface of the image bearing member by irradiation of signal light in accordance with image information onto the image bearing member whose surface is charged; transfer means for transferring, onto a recording medium, a toner image transferred to an intermediate transfer member, the toner image being developed on the surface of the image bearing member by supply of the electrophotographic toner 3 from the developing device 20; fixing means for fixing the toner image on a surface of the recording medium to the recording medium; cleaning means for removing toner, paper powder, and the like, which are remaining on the surface of the image bearing member after the toner image is transferred to the recording medium; and another cleaning means for removing excess toner or the like which is adhered to the intermediate transfer member. Further, an image forming method of the present embodiment is carried out with use of an image forming apparatus of the present embodiment including the developing device 20 of the present embodiment.

When the electrostatic charge image is developed, a developing step is performed for each color of the toner. In the developing step, the electrostatic charge image on the electrostatic latent image bearing member 15 is made visible through a reversal developing method. As a result, a plurality of toner images of different colors are superimposed on the intermediate transfer member, so that a multicolor toner image is formed. Although the present embodiment employs an intermediate transfer method which employs the intermediate transfer member, it is also possible that the toner image is transferred to the recording medium directly from the image bearing member.

### Examples

The following describes Examples and Comparative Examples according to the present invention. The present invention is not limited to the present examples unless it goes beyond the scope of the present invention. In the following Examples and Comparative Examples, measurements were performed by using a two component developer containing a toner (electrophotographic toner) and a carrier (magnetic carrier). First, production methods of the toner and the carrier which are used in the present examples and the comparative examples are explained.

### (Production of Toner)

The following materials were preliminarily mixed with use of a Henschel Mixer, and thereafter, fused and kneaded with use of a twin-screw extrusion-kneader. A kneaded material obtained as described above was roughly ground with use of a cutting mill, and thereafter, finely pulverized with use of a jet mill. A pulverized product obtained as described above was then classified with use of an air classifier. In this way, toner base particles having an average particle size of 6.5 μm were produced.

Resin . . . (T1) Polyester resin (acid number: 21 mgKOH/g)

Aromatic alcohol component: PO-BPA and EP-BPA

Acid component: fumaric acid and mellitic anhydride
87.5% by weight

### Colorant . . . C.I. Pigment Blue 15:1

5% by weight
   Wax . . . Nonpolar paraffin wax

DSC peak 78° C.

Mw (weight average molecular weight) 8.32×10²)
6% by weight
   Charge control agent . . . Product name: LR-147 (Japan Carlit Co., Ltd.)
1.5% by weight

To 97.8% by weight of the toner base particles produced as described above, (i) 1.2% by weight of silica which was hydrophobized with i-butyltrimethoxysilane and had a volume average particle size of 100 nm and (ii) 1.0% by weight of silica fine particles which were hydrophobized with HMDS and had a volume average particle size of 12 nm were added, and then mixed with use of the Henschel Mixer so that the silica and the silica particles were externally added. In this way, a cyan evaluation toner (cyan toner for evaluation) was produced. A substance name of the charge control agent used here, i.e., LR-147, is “Boro bis (1.1-diphenyl-1-oxo-acetyl)potassium Salt” and represented by a chemical formula of C₂₈H₂₀BKO₆.

### (Production of Resin-Coated Carrier)

The following amounts (parts) of silicone resin, electrically conductive particles, a charge control agent, and a coupling agent were dispersed into a toluene solution so that a coating resin solution was produced. Specifically, the electrically conductive particles were dispersed into a toluene solution with use of a dispersing agent so as to produce a dispersion liquid in advance. After a predetermined solution of the charge control agent and a predetermined solution of the coupling agent were produced, these solutions were mixed and dispersed in the toluene and further stirred with use of a three-one motor for 5 minutes. As a result, the coating resin solution was prepared. The coating resin solution was then mixed with 1000 parts by weight of magnetic core particles (ferrite core materials) having a volume average particle size of 45 μm, and put in a string machine and mixed. From a mixture obtained as described above, the toluene was removed by heating under a reduced pressure so that solution-applied layers were formed on respective surfaces of the magnetic core particles. Obtained particles were heated for an hour at 200° C. so that the solution-applied layers were cured and turned into resin coating layers, and then sieved with use of a 100-mesh sieve.

In this way, the resin-coated carrier was produced.

Silicone resin . . . Product name: SR2411 (manufactured by Dow Corning Toray Co., Ltd.)

20% silicone resin solution
100 parts by weight
   Electrically conductive particles . . . Product name: VULCANXC72 (manufactured by Cabot Corporation)

Electrically conductive carbon black toluene-dispersed solution, 15% solid content concentration solution
5 parts by weight
   Charge control agent . . . Product name: LR-147 (manufactured by Japan Carlit Co., Ltd)

Charge control agent for negative electric charge, solution
20 parts by weight
   Coupling agent: Product name: SH6020 (manufactured by Dow Corning Toray Co., Ltd.)

100% solution
1 part by weight

Next, a measurement method and an evaluation method used in the later-described Examples and Comparative Examples are explained.

### (Measurement of Resistance Value of Carrier Particles)

An electric resistance value of resin-coated carrier particles (i.e., carrier particles for development of electrostatic latent images) produced as above was measured under a condition at a room temperature and a normal humidity, with use of a bridge resistance-measuring jig which includes electrodes facing with each other at a distance of 1 mm and in which an electrode area for measurement is 40×16 mm². Specifically, 0.2 mg of the resin-coated carrier was extracted as a sample for measurement with use of an electronic balance etc., and then inserted between the electrodes, facing each other, of the bridge resistance-measuring jig. Then, the resin-coated carrier between the electrodes was arranged to form bridges, with use of magnets provided behind the electrodes. Here, the bridge resistance-measuring jig was tapped 5 to 6 times so that the resin-coated carrier was evenly provided in each bridge. After the resin-coated carrier in the bridges was evenly arranged, a voltage which generates an electric field of 4×10³ (V/cm) was applied. Subsequently, a current value was measured with use of a digital electrometer (ADVANTEST CORPORATION:R8340) and the electric resistance value (carrier resistance value) was calculated.

### (Measurement of Resistance Value of Magnetic Core Particles)

A resistance of the magnetic core particles (hereinafter referred to as core particles) which have not yet been coated with resin was measured by the same resistance measuring means as that of the resin-coated carrier particles. The core particles which have not yet been coated with resin were set in the bridge resistance-measuring jig. Thereafter, a voltage which generates an electric field of 1×10³ (V/cm) was applied and a current value was measured so that an electric resistance value (core particles resistance value) was calculated.

### (Evaluation of Adherence of Carrier and Photographic Fog in Background Area)

Adherence of the resin-coated carrier and photographic fog in a background area were evaluated with use of a digital color copier (SHARP CORPORATION MX-6000N) employing a two component developing device. The two component developing device was supplied with the cyan evaluation toner produced as above and a developer made by mixing the resin-coated carrier and the cyan evaluation toner at a proportion of 7:100. Specifically, the evaluation was carried out as follows. First, a process cartridge including a developing cartridge (developing device 20) and a photoreceptor drum which was an electrostatic latent image bearing member were set in an dedicated test bench. Next, a simulated development was carried out with use of an external high-voltage power supply. In the process of the simulated development, the process cartridge was stopped. Then, the resin-coated carrier adhered to a surface of a photoreceptor was collected with use of a mending tape (Sumitomo 3M Limited: 810-3-18), and the number of particles of the resin-coated carrier was counted. Finally, the adherence of the resin-coated carrier was evaluated by calculating a ratio of the number of particles of the resin-coated carrier with respect to our specified number. In addition, photographic fog in the background area was measured with use of a Spectrodensitometer (X-Rite, Incorporated; X-rite 939), and evaluated by comparing a density in the background area with that in a white area.

A criterion of the adherence of the resin-coated carrier for evaluation was expressed by: F=measured number of adhered particles of the resin-coated carrier/our specified number. A case where F=0 was represented as “Excellent”; a case where F<0.5 was represented as “Good”; a case where 0.5<=F<1 was represented as “Fair”; and a case where F=>1 was represented as “Poor”. A criterion of evaluation of photographic fog in the background area was expressed by: D=measured density−criterial whiteness. A case where D=0 was represented as “Excellent”; a case where 0<D<0.01 was represented as “Good”; a case where 0.01<=D<0.02 was represented as “Fair”; and a case where D=>0.02 was represented as “Poor”. The following describes measurement results of Examples and Comparative Examples.

### Example 1

Resin-coated carriers were produced according to the method described in the (Production of Resin-Coated Carrier), but by using respective coating resin solutions containing the electrically conductive particles in respective amounts of 0 parts by weight, 5 parts by weight, 10 parts by weight, 15 parts by weight, and 20 parts by weight. Then, a resistance value of each of the resin-coated carriers was measured according to the method described in the (Measurement of Resistance Value of Carrier Particles).

Further, two component developers were produced by using (i) a cyan evaluation toner produced according to the method described in the (Production of Toner) and (ii) the respective resin-coated carriers each containing a different amount of the electrically conductive fine particles (each having a different resistance). Thereafter, each of the two component developers was supplied into the developing cartridge A. The developing cartridge A was then set in the test bench described in the (Evaluation of Adherence of Carrier and Photographic Fog in Background Area). Then, after idling of the test bench for 3 minutes under a condition at a room temperature and a normal humidity, the adherence of the resin-coated carriers and photographic fog in the background area were measured and evaluated.

### Comparative Example 1

A resin-coated carrier was produced according to the (Production of Resin-Coated Carrier), except that the charge control agent, i.e., LR-147, was replaced by a charge control agent A, i.e., a charge control agent for positive electric charge described below and that the amount of the electrically conductive particles was changed to 10 parts by weight.

Charge control agent A . . . Product name: P-51 (manufactured by ORIENT CHEMICAL INDUSTRIES CO., LTD)

Charge control agent for positive electric charge, quaternary ammonium salt, 5% methanol solution

Then, an electric resistance of the resin-coated carrier produced as above was measured in the same manner as in Example 1. Further, a two component developer was produced by using the resin-coated carrier. Regarding the two component developer, the adherence of the resin-coated carrier and photographic fog in the background area were measured and evaluated.

### Comparative Example 2

A resin-coated carrier was produced according to the (Production of Resin-Coated Carrier), except that the charge control agent, i.e., LR-147, was replaced by a charge control agent B, i.e., a charge control agent for negative electric charge described below and that the amount of the electrically conductive particles was changed to 10 parts by weight.

Charge control agent B . . . Product name: BONTRON E-84 (manufactured by ORIENT CHEMICAL INDUSTRIES CO., LTD)

Charge control agent for negative electric charge

Then, an electric resistance of the resin-coated carrier produced as above was measured in the same manner as in Example 1. Further, a two component developer was produced by using the resin-coated carrier. Regarding the two component developer, the adherence of the resin-coated carrier and photographic fog in the background area were measured and evaluated.

Table 1 shows measurement results of the carrier resistance values, and evaluation results of the adherence of the resin-coated carriers and photographic fog in the background area, regarding Example 1 and Comparative Examples 1 and 2.

TABLE 1

| | Electrically | Carrier | | |
|---|---|---|---|---|
| | Conductive | Resistance | Adherence | |
| | Particles | Value | of | Photographic |
| | (pts. wt.) | (Ωcm) | Carrier | Fog |
| Example 1 | 0 | 4.93E+13 | POOR | EXCELLENT |
| | 5 | 1.12E+10 | FAIR | EXCELLENT |
| | 10 | 8.07E+08 | EXCELLENT | EXCELLENT |
| | 15 | 8.22E+07 | GOOD | GOOD |
| | 20 | 1.41E+06 | POOR | POOR |
| Comparative | 10 | 2.88E+08 | GOOD | GOOD |
| Example 1 | | | | |
| Comparative | 10 | 1.53E+09 | FAIR | GOOD |
| Example 2 | | | | |

The result of Example 1 in Table 1 shows that the resistance value of the resin-coated carrier decreases as a content of the electrically conductive particles increases. The result further shows that the adherence of the resin-coated carrier decreases and the photographic fog rarely occurs if the resistance value is 1×10⁷ Ωcm to 1×10¹² Ωcm in the electric field of 4×10³ V/cm. The result furthermore shows that the resin-coated carrier employing the charge control agent composed of the same components as components of the charge control agent of the toner is superior, in terms of the adherence of the resin-coated carrier and photographic fog, to (i) the resin-coated carrier employing the charge control agent for positive electric charge of Comparative Example 1 which has a different polarity from a polarity of the charge control agent of the toner and to (ii) the resin-coated carrier employing the charge control agent for negative electric charge of Comparative Example 2 which has the same polarity as the polarity of the charge control agent of the toner but which is made of different materials.

That is, in a case where the two component developer employs the resin-coated carrier that exhibits the electric resistance of 1×10⁷ Ωcm to 1×10¹² Ωcm in the electric field of 4×10³ V/cm and that employs the charge control agent composed of the same components as components of the charge control agent of the toner, the adherence of the resin-coated carrier is drastically reduced, and moreover, a charging property of the toner which is a main factor to cause photographic fog is stabilized.

### Example 2

Magnetic core particles each having a different resistance value were prepared, and the electric resistance values were measured according to the (Measurement of Resistance Value of Magnetic Core Particles). Further, resin-coated carriers were produced in such a manner that surfaces of the magnetic core particles each having a different resistance value were coated with resin according to the method described in the (Production of Resin-Coated Carrier).

Further, two component developers were produced by using (i) a cyan evaluation toner produced according to the method described in the (Production of Toner) and (ii) the respective resin-coated carriers each having a different resistance. Thereafter, each of the two component developers was supplied into the developing cartridge A. The developing cartridge A was set in the test bench described in the (Evaluation of Adherence of Carrier and Photographic Fog in Background Area). Then, after idling of the test bench for 3 minutes under a condition at a room temperature and a normal humidity, the adherence of the resin-coated carrier and photographic fog in the background area were measured. Table 2 shows resistance values of the respective magnetic core particles, and evaluation results of the adherence of the resin-coated carrier and photographic fog in the background area of the two component developers employing the respective magnetic core particles.

TABLE 2

| | Resistance | | |
|---|---|---|---|
| | Value of Core | Adherence | |
| | Particles | of | Photographic |
| | (Ωcm) | Carrier | Fog |
| Example 2 | 6.61E+06 | POOR | POOR |
| | 3.46E+07 | EXCELLENT | EXCELLENT |
| | 2.45E+08 | EXCELLENT | EXCELLENT |
| | 1.05E+10 | POOR | GOOD |

Here, the resistance values of the magnetic core particles which were measured in the (Measurement of Resistance Value of Magnetic Particles) also affect the resistance values of the resin-coated carriers which have been coated with resin. Especially a low resistance value of magnetic core particles becomes a cause of leakage of charge from the electrophotographic toner which once has been charged. This leads to photographic fog. This also causes the resin-coated carrier to easily adhere to a surface of the electrostatic latent image bearing member due to charge injection caused by developing bias.

Table 2 shows that in a case where the electric resistance value of the magnetic core particles which have not yet been coated with resin is within a range of 1×10⁷ Ωcm to 1×10⁹ Ωcm in the electric field of 1×10³ V/cm, the adherence of the resin-coated carrier to the surface of the electrostatic latent image bearing member is inhibited and also photographic fog is inhibited.

### Example 3

Magnetic core particles each having a different volume average particle size were prepared and coated with resin according to the method described in the (Production of Resin-Coated Carrier), so that resin-coated carriers were produced. Then, evaluation was carried out on the resin-coated carriers employing the magnetic core particles each having the different volume average particle size, according to the (Evaluation of Adherence of Carrier and Photographic Fog in Background). Table 3 shows results of the evaluation.

TABLE 3

| | Volume | | |
|---|---|---|---|
| | Average | Adherence | |
| | Particle Size | of | Photographic |
| | (μm) | Carrier | Fog |
| Example 3 | 20 | POOR | FAIR |
| | 35 | FAIR | GOOD |
| | 45 | EXCELLENT | EXCELLENT |
| | 55 | EXCELLENT | EXCELLENT |
| | 90 | EXCELLENT | GOOD |

Table 3 shows that in a case where the volume average particle size of the resin-coated carrier is 20 μm or less, each of the resin-coated carriers is caused to easily adhere to the surface of the electrostatic latent image bearing member because a holding power of a magnetic roller incorporated in the developer bearing member becomes too small to hold the resin-coated carrier. In addition, in such a case, the resin-coated carrier tends to be mixed ununiformly with the toner. This extends charge distribution of the toner. As a result, photographic fog occurs. Accordingly, it is clear from Table 3 that it becomes possible, by arranging a resin-coated carrier to have a volume average particle size of 25 μm to 60 μm, to inhibit the adherence to the surface of the electrostatic latent image bearing member and further photographic fog.

### Example 4

Resin-coated carrier particles were produced according to the method described in the (Production of Resin-Coated

Carrier), but by using respective coating resin solutions containing the electrically conductive particles in respective amounts of 0 parts by weight, 5 parts by weight, 10 parts by weight, 15 parts by weight, and 20 parts by weight. Then, an electric resistance value of each of the resin-coated carrier particles was measured according to the method described in the (Measurement of Resistance Value of Carrier Particles).

Further, two component developers were produced by using (i) a cyan evaluation toner produced according to the method described in the (Production of Toner) and (ii) the respective resin-coated carriers each containing a different amount of the electrically conductive fine particles (each having a different resistance). Thereafter, each of the two component developers was supplied into the developing cartridge A. The developing cartridge A was then set in the test bench described in the (Evaluation of Adherence of Carrier and Image Fog in Background Area). Then, after idling of the test bench for 3 minutes under a condition at a room temperature and a normal humidity, the adherence of the resin-coated carrier and photographic fog in the background area were measured and evaluated. Table 4 shows results of the evaluation.

TABLE 4

| | Charge | Carrier | | |
|---|---|---|---|---|
| | Control | Resistance | Adherence | |
| | Agent | Value | of | Photographic |
| | (pts. wt.) | (Ωcm) | Carrier | Fog |
| Example 4 | 0 | 1.16E+09 | FAIR | FAIR |
| | 5 | 2.14E+08 | GOOD | GOOD |
| | 10 | 8.07E+08 | EXCELLENT | EXCELLENT |
| | 15 | 1.28E+08 | GOOD | EXCELLENT |
| | 20 | 5.28E+07 | POOR | GOOD |

Table 4 shows that although the adherence of the resin-coated carrier increases as an amount of the charge control agent added increases, the adherence of the resin-coated carrier increases when the amount of the charge control agent becomes 15 parts by weight or more. Accordingly, it is clear that a coating layer of each of the resin-coated carriers is preferably a resin composition containing (i) 10 parts by weight or less of the electrically conductive particles with respect to 100 parts by weight of silicone resin (in the present Example, the silicone resin is a crosslinkable silicone resin) and (ii) 5 parts to 15 parts by weight of the charge control agent composed of the same components as the charge control agent of the toner, with respect to 100 parts by weight of the silicone resin.

### Example 5

A two component developer was produced by using (i) a toner produced according to the (Production of Toner) and (ii) a resin-coated carrier produced according to the (Production of Resin-Coated Carrier) except that the amount of the charge control agent was changed to 10 parts by weight. With use of the two-component developer, 50000 sheets of solid images were photographed under a condition at a room temperature and a normal humidity. Thereafter, the developing cartridge A was set back in the test bench, and the (Evaluation of Adherence of Carrier and Photographic Fog in Background Area) was carried out. As Comparative Example 3, another resin-coated carrier was produced in the same manner as in (Comparative Example 1) except that the amount of the charge control agent was changed to 10 parts by weight, and a carrier resistance value of the another resin-coated carrier was measured. Further, a two component developer was produced by using the another resin-coated carrier. Regarding the two component developer, the adherence of the resin-coated carrier and photographic fog in the background area were measured and evaluated in the same manner as in (Example 5). Similarly, as Comparative Example 4, a still another resin-coated carrier was produced in the same manner as in (Comparative Example 2) except that the amount of the charge control agent was changed to 10 parts by weight. The carrier resistance value of the still another resin-coated carrier was measured. Further, a two component developer was produced by using the still another resin-coated carrier. Regarding this two component developer, the adherence of the resin-coated carrier and photographic fog in the background area were measured and evaluated in the same manner as in (Example 5).

Table 5 shows results of Example 5 and Comparative. Examples 3 and 4.

TABLE 5

| | Charge | Carrier | | |
|---|---|---|---|---|
| | Control | Resistance | Adherence | |
| | Agent | Value | of | Photographic |
| | (pts. wt.) | (Ωcm) | Carrier | Fog |
| Example 5 | 10 | 8.07E+08 | EXCELLENT | EXCELLENT |
| Comparative | 10 | 2.88E+08 | GOOD | FAIR |
| Example 1 | | | | |
| Comparative | 10 | 1.53E+09 | GOOD | POOR |
| Example 2 | | | | |

It is clear from Table 5 that the two component developer produced in (Example 5) kept a toner charge amount without deterioration in charging stability of the toner even over a long period of time, and did not cause photographic fog in the background area on the surface of the electrostatic latent image bearing member. Further, the two component developer of (Example 5) did not cause the adherence of the resin-coated carrier to the surface of the electrostatic image bearing member; that is, the resin-coated carrier did not deteriorate. That is, the two component developer of (Example 5) was much superior to the two component developer of (Comparative Example 3) and to the two component developer of (Comparative Example 4).

The results show the following. It becomes possible to achieve a good charging property of the electrophotographic toner not only initially but also over a long period of time, by using, as a magnetic carrier in a two component developer, a magnetic carrier (i) which contains, in a coating layer coating the magnetic carrier, a charge control agent composed of the same components as components of a charge control agent contained in a electrophotographic toner used in the two component developer and (ii) which exhibits an electric resistance value of 1×10⁷ Ωcm to 1×10¹² Ωcm in an electric field of 4×10³ V/cm. This makes it possible to stably output high-quality images without causing photographic fog in background area on an electrostatic latent image bearing member.

A magnetic carrier according to the present invention is a magnetic carrier constituting, together with an electrophotographic toner, a two component developer, the magnetic carrier having a magnetic core material whose surface is coated with a coating layer containing electrically conductive particles and a charge control agent composed of same components as components of a charge control agent contained in the electrophotographic toner, the magnetic carrier exhibiting an electric resistance value of 8.22×10⁷ Ωcm to 1.12×10¹⁰ Ωcm in an electric field of 4×10³ V/cm.

The magnetic carrier according to the present invention may also be arranged, in the above arrangement, such that the magnetic core material exhibits an electric resistance value of 3.46×10⁷ Ωcm to 2.45×10⁸ Ωcm in an electric field of 1×10³ V/cm. If the magnetic core material of the magnetic carrier exhibits the resistance value within this range, then it is possible to more effectively inhibit the magnetic carrier from adhering to the surface of the electrostatic latent image bearing member, and further to inhibit the photographic fog.

The magnetic carrier according to the present invention may have, in the above arrangement, a volume average particle size of 25 μm to 60 μm. If the magnetic carrier has such a volume average particle size of 25 μm to 60 μm, then an effect of inhibiting the magnetic carrier from adhering to the surface of the electrostatic latent image bearing member is enhanced, and in addition, an effect of inhibiting the photographic fog is enhanced.

The magnetic carrier according to the present invention may be arranged, in the above arrangement, such that the coating layer is made of a resin composition containing (i) the electrically conductive particles in an amount of 10 parts by weight or less with respect to 100 parts by weight of silicone resin and (ii) the charge control agent in an amount of 5 parts to 15 parts by weight with respect to 100 parts by weight of the silicone resin.

If a surface of the magnetic carrier is coated with the resin composition containing (i) the electrically conductive particles in an amount of 10 parts by weight or less with respect to 100 parts by weight of silicone resin and (ii) the charge control agent in an amount of 5 parts to 15 parts by weight with respect to 100 parts by weight of the silicone resin, then it is possible to more stably charge the electrophotographic toner.

In order to solve the foregoing problems, a two component developer according to the present invention contains (i) any one of the above-described magnetic carriers and (ii) an electrophotographic toner.

With this arrangement, the two component developer attains the same effect as the magnetic carrier, and prevents the charging property of the electrophotographic toner from deteriorating even over a long period of time. As such, use of the two component developer arranged as described above makes it possible to reproduce a highly fine image, and to stably form a high quality image that is excellent in color reproduction and has a high image density but that has less image defects such as photographic fog.

In order to solve the foregoing problems, a developing unit according to the present invention is a developing unit into which the two component developer described above is supplied. Such a developing unit makes it possible to always perform stable development without deterioration in the charging property of the electrophotographic toner even over a long period of time, and provides the same effect as described above.

Further, a developing unit according to the present invention may further include, in the above arrangement, a stirring mechanism for mixing the two component developer supplied into the developing unit; a developer bearing member for holding the two component developer; and a developer controlling member for controlling an amount of the electrophotographic toner to be supplied to an image bearing member, the electrophotographic toner being held on a surface of the developer bearing member.

In order to solve the foregoing problems, a developing device according to the present invention develops an image with use of any one of developing units as described above. Such a developing device makes it possible to always perform stable development without deterioration in the charging property of the electrophotographic toner even over a long period of time, and provides the same effect as described above.

In order to solve the foregoing problems, an image forming apparatus according to the present invention includes: the developing device as described above; and transfer means including an intermediate transfer member on which a plurality of toner images of different colors are formed.

According to the arrangement, since the image forming apparatus employs the two component developer according to the present invention, a charge amount of the electrophotographic toner is stabilized without deterioration in the charging property of the electrophotographic toner even over a long period of time. Accordingly, effects of the magnetic carrier according to the present invention and the two component developer according to the present invention are exerted more effectively in a mechanism which includes the intermediate transfer member and which transfers a toner image twice.

In order to solve the foregoing problems, an image forming method according to the present invention includes the step of forming an image by using the two component developer as described above.

According to the method, the two component developer according to the present invention is used, and thereby it is possible to stably form high quality images over a long period of time.

Further, the image forming method described above may further include the step of performing transfer with an intermediate transfer method in which a plurality of toner images of different colors are formed on an intermediate transfer member. In the method, the two component developer according to the present invention is used, and the charging amount of the electrophotographic toner is stabilized without deterioration in the charging property of the electrophotographic toner even over a long period of time. Accordingly, the effects of the magnetic carrier according to the present invention and the two component developer according to the present invention are exerted more effectively in the mechanism which includes the intermediate transfer member and which transfers a toner image twice.

The embodiments discussed in the foregoing description of embodiments and concrete examples serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below. Further, needless to say that numerical values out of the ranges in the Specification are included in the present invention, provided such numerical values are within a reasonable range which does not go against the spirit of the present invention.

### Industrial Applicability

A two component developer employing resin coating carrier particles of the present invention is suitably applicable to an image forming apparatus such as an electrophotographic copier, a printer, and a facsimile.

1. A magnetic carrier constituting, together with an electrophotographic toner, a two component developer,
the magnetic carrier having a magnetic core material whose surface is coated with a coating layer containing electrically conductive particles and a charge control agent composed of same components as components of a charge control agent contained in the electrophotographic toner,
the magnetic carrier exhibiting an electric resistance value of 8.22×10⁷ Ωcm to 1.12×10¹⁰ Ωcm in an electric field of 4×10³ V/cm.

2. The magnetic carrier according to claim 1, wherein the magnetic core material exhibits an electric resistance value of 3.46×10⁷ Ωcm to 2.45×10⁸ Ωcm in an electric field of 1×10³ V/cm.

3. The magnetic carrier according to claim 1, having a volume average particle size of 25 μm to 60 μm.

4. The magnetic carrier according to claim 1, wherein the coating layer is made of a resin composition containing (i) the electrically conductive particles in an amount of 10 parts by weight or less with respect to 100 parts by weight of silicone resin and (ii) the charge control agent in an amount of 5 parts to 15 parts by weight with respect to 100 parts by weight of the silicone resin.

5. A developer according to claim 1, wherein the coating layer contains a silane coupling agent.

6. A developer according to claim 5, wherein the silane coupling agent contains an amino group.

7. The magnetic carrier according to claim 1, wherein the electrophotographic toner has a volume average particle size of 5 μm to 7 μm.

8. A two component developer comprising:
a magnetic carrier as set forth claim 1; and
an electrophotographic toner.

9. A developing unit into which a two component developer as set forth in claim 8 is supplied.

10. The developing unit according to claim 9, further comprising:
a stirring mechanism for mixing the two component developer supplied into the developing unit;
a developer bearing member for holding the two component developer; and
a developer controlling member for controlling an amount of the electrophotographic toner to be supplied to an image bearing member, the electrophotographic toner being held on a surface of the developer bearing member.

11. A developing device developing an image with use of a developing unit as set forth in claim 9.

12. An image forming apparatus comprising:
a developing device as set forth in claim 11; and
transfer means including an intermediate transfer member on which a plurality of toner images of different colors are formed.

13. An image forming method comprising the step of forming an image by using a two component developer as set forth in claim 8.

14. The image forming method according to claim 13, further comprising the step of performing transfer by an intermediate transfer method in which a plurality of toner images of different colors are formed on an intermediate transfer member.
